(19) United States
(12) Patent Application Publication
(10) Pub. No.: US 2026/0314651 A1
(43) Pub. Date: Oct. 15, 2026

(54) METHOD AND APPARATUS FOR APPLYING SUSCEPTOR WIRES TO AN AEROSOL-FORMING SUBSTRATE

(71) Applicant: Philip Morris Products S.A., Neuchatel (CH)

(72) Inventors: Oleg MIRONOV, Cudrefin (CH); Andreas Michael ROSSOLL, Le Mont-sur-Lausanne (CH); Alessio DI GIUSEPPE, Modena (IT); Lorenzo BENASSI, Bologna (IT); Julien VIDAL, Peseux (CH)

(73) Assignee: Philip Morris Products S.A., Neuchatel (CH)

(21) Appl. No.: 19/156,936

(22) PCT Filed: Feb. 21, 2024
(86) PCT No.: PCT/EP2024/054418

§ 371 Date: Aug. 15, 2025

(30) Foreign Application Priority Data
Feb. 22, 2023 (EP) 23157999

(51) Int. Cl. A24B 15/167; A24F 40/465; H05B 6/10

(52) U.S. Cl. CPC A24B 15/167; H05B 6/105; A24F 40/465

(57) ABSTRACT

A method of applying susceptor wires to an aerosol-forming substrate for an inductively heatable aerosol-generating article is provided, the method including the steps of: providing an aerosol-forming substrate in the form of a sheet material; providing a plurality of susceptor wires from a wire supply; and depositing the plurality of susceptor wires on a main outer surface of the sheet material, the aerosol-forming substrate being made from a substrate slurry casted into the form of the sheet material, and the plurality of susceptor wires being deposited on the casted substrate slurry.

The present disclosure relates to a method of applying susceptor wires to an aerosol-forming substrate for use in an inductively heatable aerosol-generating article and to an apparatus for applying susceptor wires to an aerosol-forming, in particular for use in a method according to the present disclosure.

Aerosol-generating systems using induction heating for generating inhalable aerosols are generally known from prior art. Such systems may comprise an inductively heating aerosol-generating device and a separate aerosol-generating article for use with the device. Among other components, the article may include an aerosol-forming substrate capable to form an inhalable aerosol when heated, and an inductively heatable susceptor arrangement in thermal proximity or direct physical contact with the substrate for heating the same. Inductive heating of the susceptor arrangement is accomplished by interaction of the susceptor arrangement with an alternating magnetic field that is provided by the aerosol-generating device. In operation, the alternating magnetic field induces at least one of heat-generating eddy currents or hysteresis losses in the susceptor arrangement, causing the latter to heat up to a temperature sufficient to release volatile compounds from the heated substrate, which subsequently can cool down to form an aerosol.

Depending on the type of substrate and the shape of the article, different configurations of susceptor element susceptor arrangements are known. As an example, the article may comprise a single solid susceptor element, such as a susceptor strip, that is embedded in a solid or gel-like aerosol-forming substrate within a substrate portion of the article. While solid susceptor element are easily available at low cost, they form a single central heat source which can result in inhomogeneous temperature distribution over the substrate portion. This is because direct heating of the substrate only occurs in the immediate vicinity of the susceptor element, while peripheral regions of the substrate portions are heated only indirectly by means of heat conduction across adjacent substrate layers. In particular, the high temperature gradient may cause the inner regions of the substrate portion in the vicinity of the susceptor element to overheat, whereas the temperature in the peripheral regions of the substrate portion may be too low for volatilizing the substrate. Moreover, the heating efficiency of this configuration is rather sensitive to a proper positioning of the susceptor element within the substrate. All this may cause a non-optimal exploitation of the aerosol-forming substrate. Alternatively, articles have been proposed that comprise spherical or quasi-spherical susceptor particles homogenously disturbed throughout the aerosol-forming substrate. Whilst leading to a more homogenous heating of the substrate, the heating efficiency of this susceptor configuration is limited which may also impact the extraction efficiency.

Therefore, it would be desirable to have an aerosol-forming substrate with advantages of the prior art, while mitigating their limitations. In particular, it would be desirable to have method of applying susceptor wires to an aerosol-forming substrate for use in an inductively heatable aerosol-generating article such that the aerosol-forming substrate may provide a more efficient heating and exploitation of the aerosol-forming substrate.

According to an aspect of the present invention, a method of applying susceptor wires to an aerosol-forming substrate for use in an inductively heatable aerosol-generating article is disclosed.

The method comprises the step of providing an aerosol-forming substrate in the form a sheet material.

The method further comprises the step of providing a plurality of susceptor wires from a wire supply.

The method also comprises the step of depositing the plurality of susceptor wires on a main outer surface of the sheet material.

In general, the term “wire” as used herein refers to an elongate element having a greater extent in one predominant dimension, the length extension, than in the two remaining dimensions perpendicular (transverse) to the predominant dimension. In other words, the length extension of the susceptor wire is greater than its width/height or diameter. In particular, the term “susceptor wire” may refer to a susceptor element that has a length dimension greater than any transverse dimension perpendicular to the length dimension. Especially, the susceptor wire may be a continuous susceptor wire. Accordingly, as used herein, the term “transverse dimension” refers to a dimension of the susceptor wire perpendicular to the predominant dimension (length extension).

As compared to a single solid susceptor element, usage of a plurality of susceptor wires which are dispersed throughout the aerosol-forming substrate in the final product, that is, the aerosol-generating article, advantageously results in a more homogenous heat distribution over the substrate without any significant temperature gradients across different substrate regions. Furthermore, where the susceptor material of the susceptor wires has a high thermal conductivity, the homogeneity of the heat distribution is further enhanced by the fact that a substrate comprising a plurality of susceptor wires dispersed therein exhibits an increased equivalent thermal conductivity as compared to a substrate without susceptor elements or with a single solid susceptor element only. Moreover, in achieving a homogeneous heat distribution, the proposed susceptor arrangement is less sensitive to the positioning of the susceptor wires as compared to a single solid susceptor element.

Most important, it was found that the geometry, in particular the relative dimensions of the susceptor wires have a major impact on the heating efficiency and thus on the extraction efficiency of the substrate. In this regard, it was found that susceptor wires (having finite length in the final product) are less prone to demagnetization effects as compared to rather equidimensional susceptor elements, such as spherical or quasi-spherical susceptor particles. This can be explained as follows: When placing a susceptor wire (of finite length) in an external magnetic field, it becomes progressively magnetized. As the external field increases, so does the internal magnetization. This process continues until the magnetization reaches the magnetic saturation point of the material, beyond which no further magnetization can occur. As a result, the magnetization of the susceptor wire causes an accumulation of magnetic charge density at opposite ends of the susceptor wire as seen in the direction of the external magnetic field. As a consequence, the susceptor wire generates a magnetic field that causes a self-interaction with its material. This field lies along the same direction as the external magnetic field, but points opposite to it, and thus is termed the demagnetization field. The demagnetizing field depends on the geometrical shape of the susceptor wire, but not on its absolute dimensions. Provided the susceptor wire responds to the external magnetic field changes, the demagnetizing field is generally assumed to be proportional to the magnetization in each direction, related by a geometry dependent constant of proportionality that is known as the demagnetization factor. The demagnetization factor depends on the shape of the susceptor wire as well as on its relative orientation to the external magnetic field. To this extent, it has been found that an external magnetic field running through a susceptor wire, with a length dimension significantly greater than any transverse dimension perpendicular to the length dimension, generates a weaker or even negligible demagnetization field as compared to a non-elongate (equidimensional) susceptor element, such as a spherical or quasi-spherical susceptor element. This can be intuitively understood since in a properly aligned susceptor wire the accumulated magnetic charge densities at the opposite ends of the susceptor wire are more spatially distanced from each other. This causes the demagnetizing field to significantly reduce its intensity and thus to have a lesser impact on the magnetization field, which is responsible for the power losses. As a result, power losses and thus heating efficiency is greater than for a susceptor wire than for a non-elongate (equidimensional) susceptor element, such as spherical or quasi-spherical susceptor element. This applies especially where the orientation of the magnetic field is substantially parallel to the length dimension of the susceptor wire, in which configuration the heating performance is at maximum. Yet, it has been found that the susceptor wires do not necessarily need to be in perfect parallel alignment with the external magnetic field direction. Even if the susceptor wires are aligned in a certain angular range about the orientation of the external magnetic field, the overall heating performance is still higher than for a susceptor arrangement with randomly oriented susceptor wires.

As stated above, the heating performance is at maximum for a substantially parallel alignment. Accordingly, the susceptor wires are preferably aligned substantially parallel to each other. As used herein, the term “substantially parallel” is understood as “parallel +5°degrees deviation from a parallel arrangement”.

Whenever in this disclosure a number or a range is given for a plurality of a objects, such as for the plurality of susceptor wires, this means that the number or the range applies to at least 60 percent, in particular at least 70 percent, more particularly at least 80 percent, especially at least 90 percent of all objects out of the plurality of a objects, preferably for all objects out of the plurality of a objects. For example, where the present disclosure states that the susceptor wires are aligned substantially parallel to each other, this means that at least 60 percent, in particular at least 70 percent, more particularly at least 80 percent, especially at least 90 percent of all susceptor wires are aligned substantially parallel.

Therefore, an inductively heated aerosol-generating article may be provided with a more homogeneous heat distribution within the aerosol-forming substrate due to the presence of a plurality of susceptor wires distributed over the main outer surface of the sheet material, while at the same time the susceptor wires are optimally aligned with respect to the alternating magnetic field provided by the aerosol-generating device, therefore providing an high heating efficiency as compared to randomly oriented susceptor wires. In addition, depending on the desired heating efficiency, an optimal density of the deposited susceptor wires per square area unit of the main outer surface of the sheet material may be provided.

In a preferred embodiment, the plurality of susceptor wires may be continuous susceptor wires, each provided from a bobbin being part of the wire supply. A plurality of the susceptor wires may be provided to the wire supply coiled on a single bobbin or each susceptor wire may be coiled on an assigned bobbin. The susceptor wires may be cut to the desired length extension previous to or after deposition on the main outer surface of the sheet material. Preferably, the susceptor wires may be deposited on the main outer surface of the sheet material without cutting. The wire supply may be preferably arranged vertically above the sheet material at a place of deposition on the main outer surface.

As used herein, the term “arranged vertically above” is understood as lying in a projection of a plane of the sheet material or a projection of a plane tangent to the sheet material at the place of wire deposition above the sheet material.

As used herein, the term “place of wire deposition” may refer to the current surface portion of the sheet material where the susceptor wires are deposited at a given time during the depositing process on the main outer surface of the sheet material.

By providing the wire supply arranged vertically above the sheet material, the susceptor wires may be easily deposited on the main outer surface of the sheet material by gravity. Of course, additional elements such as guiding elements and/or rollers for the susceptor wires may be provided to facilitate deposition of the susceptor wires on the main outer surface of the sheet material.

Alternatively, the wire supply may be arranged vertically below the sheet material at a place of deposition on the main surface.

According to another alternative, the wire supply may be preferably arranged horizontally beside the sheet material at a place of deposition on the main surface. As used herein, the term “arranged horizontally beside” is understood as lying in a projection of a plane of the sheet material or a projection of a plane tangent to the sheet material at the place of deposition lateral to the sheet material when the wire supply is operational conditions.

During depositing the susceptor wires on the main outer surface of the sheet material, the sheet material and the wire supply may be moved relative to each other, either continuously or stepwise, therefore allowing depositing the susceptor wires on a large portion of the main outer surface of the sheet material. This in particular advantageous when the sheet material is provided as a continuous substrate sheet.

In particular, during depositing the susceptor wires on the main outer surface of the sheet material, the sheet material may be moved relative to (in particular past) the wire supply in a conveying direction, either continuously or stepwise. This allows for a deposition of the susceptor wires on a large portion of the main outer surface of the susceptor material, preferably a continuous deposition of the susceptor wires on the main outer surface of the sheet material provided as a continuous substrate sheet. The conveying direction may be parallel to a plane defined by the sheet material or parallel to a plane tangent to the sheet material at a place of wire deposition. This is also in particular advantageous when the sheet material is provided as a continuous substrate sheet, therefore optimizing the method of applying susceptor wires to the aerosol-forming substrate.

Immediately before the deposition on the main outer surface of the sheet material a projection of the length extension of the susceptor wires onto the plane defined by the sheet material or onto the plane tangent to the sheet material at the place of wire deposition may be substantially parallel to the conveying direction. In this case, the substantial parallelism of the projection of the length extension and of the conveying direction allows for an improved deposition of the susceptor wires, since alignment of the susceptor wires is supported by the movement of the sheet material in the conveying direction, therefore allowing for an alignment of the susceptor wires substantially parallel to each other and to the conveying direction.

Preferably, the sheet material may be moved relative to (in particular past) the wire supply in the conveying direction by means of a conveyor belt or by means of one or more rollers.

Alternatively or additionally, during depositing the susceptor wires on the main outer surface of the sheet material, the wire supply may be moved relative to (in particular across/along) the sheet material in a plane parallel to a plane defined by the sheet material or parallel to a plane tangent to the sheet material at a place of wire deposition. In particular, the wire supply may be moved in a direction parallel to a projection of the length extension of the susceptor wires onto the respective plane immediately before the deposition on the main outer surface of the sheet material. The susceptor wires may be therefore deposited on the main outer surface of the sheet material with their length extension running in any arbitrary direction. As an example, the substrate wires may be deposited on the main outer surface of the sheet material in a pattern running diagonally to the conveying direction, in a sinusoidal-wave pattern, a staggered (sawtooth) pattern or even perpendicular to the conveying direction.

In a preferred configuration, an angle between the length extension of the susceptor wires when leaving the wire supply and a plane defined by the sheet material may be in a range between 0 degrees and 90 degrees, in particular between 0 degrees and 80 degrees, preferably between 10 degrees and 45 degrees. It has been shown that with the preferred angle range, deposition of the susceptor wires is particularly efficient. Alternatively, an angle between the length extension of the susceptor wires when leaving the wire supply and a plane tangent to the sheet material at a place of wire deposition may be in a range between 0 degrees and 90 degrees, in particular between 0 degrees and 80 degrees, preferably between 10 degrees and 45 degrees.

The aerosol-forming substrate may be preferably made from a substrate slurry casted into the form of the sheet material, wherein the susceptor wires are deposited on the casted substrate slurry, in particular prior to drying the casted substrate slurry. This is in particular done for achieving improved bonding of the susceptor wires with the sheet material during subsequent drying. Depending on the firmness of the sheet material, in particular of the casted substrate slurry, the susceptor wires may be also at least partially embedded within the substrate sheet after or during deposition, either based on a particular set-up of the method (or apparatus) according to the present disclosure, or by virtue of dedicated means such as at least one pressing roller or the like.

As already described above, the aerosol-forming substrate in the form of the sheet material may be a continuous substrate sheet.

Preferably, the susceptor wires may be deposited on the main outer surface of the sheet material during or after crimping the continuous substrate sheet. In particular, the susceptor wires may be deposited on the main outer surface of the sheet material during or after crimping the continuous substrate sheet in a longitudinal direction. The longitudinal direction may be in particular a machine direction of the continuous substrate sheet, preferably parallel to the conveying direction. Since the sheet material is corrugated during or after crimping, deposition of the susceptor wires during or after crimping has the advantage that the created corrugations facilitate the accommodation of the susceptor wires during deposition, thereby simplifying the deposition and also improving the alignment and distribution of the susceptor wires. In addition, the susceptor wires accommodated within the corrugations may be at least partially surrounded by the sheet material. The sheet material may hence provide a clamping effect of the susceptor wires.

To further improve alignment of the susceptor wires, the susceptor wires provided from the wire supply may be fed into grooves of a crimping roller used for crimping the continuous substrate sheet such that the susceptor wires are deposited within the corrugations formed during crimping. Preferably, the number of corrugations of the continuous substrate sheet along a direction perpendicular to the longitudinal direction of crimping is in a range between 2 corrugations per centimeter of sheet material and 12 corrugations per centimeter of sheet material, in particular about 10 corrugations per centimeter of sheet material.

In order to improve the hold of the susceptor wires on the main outer surface of the sheet material, a sticky agent may be applied to the main outer surface of the sheet material prior to depositing the susceptor wires thereon. In particular, the sticky agent may comprise glycerol.

A maximum transverse dimension of the susceptor wires may be preferably in a range between 10 micrometer and 500 micrometer, in particular 20 micrometer and 150 micrometer, preferably 40 micrometer and 100 micrometer. In particular, a maximum transverse dimension of the susceptor wires may be equal to or smaller than 500 micrometer, in particular 300 micrometer, preferably 200 micrometer, more preferably 100 micrometer.

At least some of the susceptor wires may preferably have a constant maximum transverse dimension, in particular a constant cross-sectional area, along a length extension of the susceptor wire.

As used herein, the term “maximum transverse dimension” refers to a greatest dimension of the susceptor wire perpendicular to the predominant dimension (length extension).

Preferably, the maximum transverse dimension does not only have a lower limit but also an upper limit. Accordingly, a maximum transverse dimension of the susceptor wires may be equal to or smaller than 500 micrometer, in particular 300 micrometer, preferably 200 micrometer, more preferably 100 micrometer.

The heating efficiency also depends on the density of the susceptor wires within the aerosol-forming substrate. The higher the density, the larger the heating efficiency. Preferably, a linear density of the susceptor wires along a direction perpendicular to their length extension within the aerosol-forming substrate is in a range between 2 wires and 12 wires per centimeter of sheet material, in particular about 10 wires per centimeter of sheet material.

In general, the susceptor wires may have any cross-sectional shape in a plane perpendicular to the length extension. Preferably, a cross-section of the susceptor wires may have a circular shape or an oval shape or an elliptical shape or a triangular shape or a rectangular shape or a quadratic shape or polygonal shape. If the cross-section is circular, the above-mentioned maximum transverse dimension of the susceptor wires corresponds to the diameter of the susceptor wires where it is at maximum along the length extension of the susceptor wires. If the cross-section is oval or elliptical, the above-mentioned maximum transverse dimension of the susceptor wires corresponds to the length of the semimajor axis of the oval or elliptical cross-section, where it is at maximum along the length extension of the susceptor wires. If the cross-section is quadratic or in general rectangular, the above-mentioned maximum transverse dimension of the susceptor wires corresponds to the length of the edge/major edge of the quadratic/rectangular cross-section.

In general, the term “susceptor wire” as used herein refers to a susceptor element comprising a susceptor material that is capable to convert electromagnetic energy into heat when subjected to an alternating magnetic field. This may be the result of at least one hysteresis losses and eddy currents induced in the susceptor material, depending on the electrical and magnetic properties of the susceptor material. Hysteresis losses occur in ferromagnetic or ferrimagnetic susceptor materials due to magnetic domains within the material being switched under the influence of an alternating electromagnetic field. Eddy currents may be induced, if the susceptor material is electrically conductive. In case of an electrically conductive ferromagnetic susceptor or an electrically conductive ferrimagnetic susceptor, heat can be generated due to both, eddy currents and hysteresis losses.

Preferably, the susceptor wires may comprise a susceptor material which is electrically conductive and either ferromagnetic or ferrimagnetic. In particular, the susceptor material of the susceptor wires may be electrically non-conductive, but either ferromagnetic or ferrimagnetic. Alternatively, the susceptor material of the susceptor wires may be electrically conductive, but neither ferromagnetic nor ferrimagnetic.

The susceptor material of the susceptor wires may comprises or consists of a metal, for example ferritic iron, or stainless steel, in particular a grade 410, grade 420, or grade 430 stainless steel. Alternatively, the susceptor material may comprise a ferrimagnetic ceramic.

In addition to the susceptor material, the susceptor wires may further comprise a ferromagnetic or ferrimagnetic temperature marker material. While the susceptor material is optimized with regard to heat loss and thus heating efficiency, the temperature marker material is a magnetic (ferro-or ferrimagnetic) material that is chosen such as to have a Curie temperature which essentially corresponds to a predefined temperature point of the heating process The temperature marker material may have a Curie temperature below 500 °C, preferably equal to or below 400 °C, in particular equal to or below 390 °C. For example, the temperature marker material of the susceptor wires may have a Curie temperature in a range between 180 °C and 420 °C, in particular between 210 °C and 380 °C, preferably between 250 °C and 380 °C Even though the temperature marker material primarily is a functional material providing a temperature marker by its Curie temperature, it may also contribute to the inductive heating process of the susceptor arrangement.

The temperature marker material of the susceptor wires may comprises or consists of nickel or a nickel alloy.

The susceptor wires may be formed such that the susceptor material is surrounded or covered at least partially, preferably entirely by the temperature marker material.

In addition, the susceptor wires may comprise an outer protective coating surrounding the susceptor material and -if present-the temperature marker material. Preferably, the protective coating is an anti-corrosion coating. Advantageously, the protective coating makes the susceptor wires resistant to external influences, especially corrosive influences.

It is also possible that the susceptor material of the susceptor wires itself has a temperature marker function. That is, the susceptor wires may comprise a single material which acts both as a susceptor material and as a temperature marker material.

The present disclosure also relates to an apparatus for applying susceptor wires to an aerosol-forming substrate. The apparatus may be used according to the method of applying susceptor wires to an aerosol-forming substrate described above. Therefore, the description according to the method of the present disclosure may be applied accordingly to the apparatus according to the present disclosure.

The apparatus comprises a wire supply for providing a plurality of susceptor wires, a substrate supply for providing an aerosol-forming substrate in the form of a sheet material to or past the wire supply, enabling the wire supply to deposit the susceptor wires on a main outer surface of the sheet material.

Preferably, the wire supply is configured and arranged to provide and deposit the plurality of susceptor wires on the main outer surface of the sheet material in substantially parallel alignment to each other.

As already described, the wire supply may comprise one or more bobbins the susceptor wires are provided on and supplied from to the sheet material. A plurality of the susceptor wires may be provided coiled on a single bobbin or preferably, the wire supply may comprise a plurality of bobbins, one for each susceptor wire.

The bobbins each have a bobbin axis and the bobbins may be in particular arranged with respect to the bobbin axes parallel next to each other. Preferably, the bobbins may be arranged coaxially next to each other.

The substrate supply may preferably comprise a conveyor belt or one or more rollers for moving the aerosol-forming substrate in the form the sheet material relative to (in particular past) the wire supply in a conveying direction, either continuously or stepwise. The conveying direction may be preferably parallel to a plane defined by the sheet material or parallel to a plane tangent to the sheet material at a place of wire deposition.

In particular, the wire supply may be configured and arranged such that immediately before the deposition on the main outer surface of the sheet material a projection of the length extension of the susceptor wires onto the plane defined by the sheet material or onto the plane tangent to the sheet material at the place of wire deposition is substantially parallel to the conveying direction.

Also according to the present disclosure, the wire supply may be configured to be moved relative to (in particular across/along) the sheet material in a plane parallel to a plane defined by the sheet material or parallel to a plane tangent to the sheet material at a place of wire deposition, especially in a direction parallel to a projection of the length extension of the susceptor wires onto the respective plane immediately before the deposition on the main outer surface of the sheet material.

In a preferred apparatus, an angle between the length extension of the susceptor wires when leaving the wire supply and a plane defined by the sheet material may be in a range between 0 degrees and 90 degrees, in particular between 0 degrees and 80 degrees, preferably between 10 degrees and 45 degrees. Likewise, an angle between the length extension of the susceptor wires when leaving the wire supply and a plane tangent to the sheet material at a place of wire deposition may be in a range between 0 degrees and 90 degrees, in particular between 0 degrees and 80 degrees, preferably between 10 degrees and 45 degrees.

As used herein, the term “aerosol-generating article” refers to an article comprising at least one aerosol-forming substrate that is capable of releasing volatile compounds when heated in order to form an aerosol. The aerosol-generating article may be a consumable, in particular a consumable to be discarded after a single use. For example, the article may be an elongate article or a rod-shaped article. The elongate or rod-shaped article may have a shape resembling the shape of conventional cigarettes. In particular, such an article may have a circular or elliptical or oval or square or rectangular or triangular or a polygonal cross-section. As another example, the article may be a cartridge including a liquid aerosol-forming substrate to be heated.

As used herein, the term “aerosol-forming substrate” denotes a substrate formed from or comprising an aerosol-forming material that is capable of releasing volatile compounds upon heating in order to generate an aerosol. Preferably, the aerosol-forming substrate is intended to be heated rather than combusted in order to release the aerosol-forming volatile compounds. Accordingly, such a substrate may be denoted as a heat-not-burn aerosol-forming substrate. Likewise, an aerosol-generating article comprising such an aerosol-forming substrate may be denoted as a heat-not-burn aerosol-generating article.

In general, the aerosol-forming substrate may comprise at least one aerosol former and at least one sensorial material both of which are volatilizable when heated. The sensorial material may comprise at least one of a tobacco-containing material, a nicotine-containing material and a flavoring substance. Examples of suitable aerosol formers are glycerin and propylene glycol. Examples of flavoring substance may be plant extracts and natural or artificial flavors.

The aerosol-forming substrate may be a solid aerosol-forming substrate or a gel-like aerosol-forming substrate, or any combination thereof.

As mentioned above, the aerosol-forming substrate may comprise a tobacco-containing material containing volatile tobacco flavor compounds, which are released from the substrate upon heating. In particular, the aerosol-forming substrate may comprise reconstituted tobacco material or a tobacco-containing slurry. Accordingly, the aerosol-generating article may be a tobacco containing article. Alternatively or additionally, the aerosol-forming substrate may comprise a non-tobacco material. The aerosol-forming substrate may also comprise other additives and ingredients, such as nicotine or flavourants.

The aerosol-forming substrate may also be a paste-like material, a sachet of porous material comprising aerosol-forming substrate, or, for example, loose tobacco mixed with a gelling agent or sticky agent, which could include a common aerosol former such as glycerin, and which is compressed or molded into a plug.

The aerosol-forming substrate is made from a sheet material. For example, the aerosol-forming substrate may be made from a crimped tobacco sheet comprising a tobacco material, organic fibers, a binder, an aerosol former. Alternatively, the aerosol-forming substrate may be made from a sheet material including a nicotine-containing material, organic fibers, a binder, an aerosol former. As yet another alternative, the aerosol-forming substrate may be made from a sheet material containing tobacco cut filler. To this extent, it has been found that the aerosol-generating article is easy to manufacture, especially with respect to a preferred alignment of the susceptor wires relative to a pre-defined reference axis of the article, if the susceptor wires are applied to the aerosol-forming substrate when it is in the form of a sheet material. This may be the result of a manufacturing process including the deposition of the susceptor wires on an outer surface of a sheet material, either during a primary process, in which the sheet material is produced, or during a secondary process, where the sheet material is machined and combined with other semi-finished goods to obtain the final product. As a result of this, the susceptor wires may be finally disposed on an outer surface of the sheet material or at least partially embedded in the sheet material close to an outer surface of the sheet material. This can be observed even if the sheet material is subsequently machined, for example, crimped and gathered such as to form a substrate plug in the final article.

The invention is defined in the claims. However, below there is provided a non-exhaustive list of non-limiting examples. Any one or more of the features of these examples may be combined with any one or more features of another example, embodiment, or aspect described herein.

Example Ex1: A method of applying susceptor wires to an aerosol-forming substrate for use in an inductively heatable aerosol-generating article, the method comprising the steps of: providing an aerosol-forming substrate in the form a sheet material; providing a plurality of susceptor wires from a wire supply; depositing the plurality of susceptor wires on a main outer surface of the sheet material.

Example Ex2: The method according to example Ex1, wherein the plurality of susceptor wires are provided and deposited on the main outer surface of the sheet material in substantially parallel alignment to each other.

Example Ex3: The method according to any one of the preceding examples Ex1 to Ex 2, wherein the plurality of susceptor wires are continuous susceptor wires, each provided from a bobbin being part of the wire supply.

Example Ex4: The method according to any one of the preceding examples Ex1 to Ex3, wherein the wire supply is arranged vertically above the sheet material at a place of deposition on the main outer surface.

Example Ex5: The method according to any one of the preceding examples Ex1 to Ex4, wherein during depositing the susceptor wires on the main outer surface of the sheet material, the sheet material and the wire supply are moved relative to each other.

Example Ex6: The method according to any one of the preceding examples Ex1 to Ex5, wherein during depositing the susceptor wires on the main outer surface of the sheet material, the sheet material is moved relative to (in particular past) the wire supply in a conveying direction, the conveying direction preferably being parallel to a plane defined by the sheet material or parallel to a plane tangent to the sheet material at a place of wire deposition.

Example Ex7: The method according to example Ex6, wherein immediately before the deposition on the main outer surface of the sheet material a projection of the length extension of the susceptor wires onto the plane defined by the sheet material or onto the plane tangent to the sheet material at the place of wire deposition is substantially parallel to the conveying direction. Example Ex8: The method according to any one of examples Ex6 or Ex7, wherein the sheet material is moved relative to (in particular past) the wire supply in the conveying direction by means of a conveyor belt or by means of one or more rollers.

Example Ex9: The method according to any one of the preceding examples Ex1 to Ex8, wherein during depositing the susceptor wires on the main outer surface of the sheet material, the wire supply is moved relative to (in particular across/along) the sheet material in a plane parallel to a plane defined by the sheet material or parallel to a plane tangent to the sheet material at a place of wire deposition, especially in a direction parallel to a projection of the length extension of the susceptor wires onto the respective plane immediately before the deposition on the main outer surface of the sheet material.

Example Ex10: The method according to any one of the preceding examples Ex1 to Ex9, wherein an angle between the length extension of the susceptor wires when leaving the wire supply and a plane defined by the sheet material is in a range between 0 degrees and 90 degrees, in particular between 0 degrees and 80 degrees, preferably between 10 degrees and 45 degrees; or wherein an angle between the length extension of the susceptor wires when leaving the wire supply and a plane tangent to the sheet material at a place of wire deposition is in a range between 0 degrees and 90 degrees, in particular between 0 degrees and 80 degrees, preferably between 10 degrees and 45 degrees.

Example Ex11: The method according to any one of examples Ex1 to Ex10, wherein the aerosol-forming substrate is made from a substrate slurry casted into the form of the sheet material, wherein the susceptor wires are deposited on the casted substrate slurry.

Example Ex12: The method according to example Ex11, wherein the susceptor wires are deposited on the main outer surface of the sheet material prior to drying the casted substrate slurry.

Example Ex13: The method according to any one of examples Ex1 to Ex12, wherein the aerosol-forming substrate in the form of the sheet material is a continuous substrate sheet.

Example Ex14: The method according to example Ex13, wherein the susceptor wires are deposited on the main outer surface of the sheet material during or after crimping the continuous substrate sheet, especially during or after crimping the continuous substrate sheet in a longitudinal direction, in particular in a machine direction of the continuous substrate sheet.

Example Ex15: The method according to example Ex14, wherein the susceptor wires provided from the wire supply are fed into grooves of a crimping roller used for crimping the continuous substrate sheet such that the susceptor wires are deposited within the corrugations formed during crimping.

Example Ex16: The method according to any one of the preceding examples Ex1 to ex 15, wherein a sticky agent is applied to the main outer surface of the sheet material prior to depositing the susceptor wires thereon.

Example Ex17: The method according to example Ex16, wherein the sticky agent comprises glycerol.

Example Ex18: The method according to any one of the preceding examples Ex1 to Ex 17, wherein a maximum transverse dimension of the susceptor wires is a range between 10 micrometer and 500 micrometer, in particular 20 micrometer and 150 micrometer, preferably 40 micrometer and 100 micrometer.

Example Ex19: The method according to any one of the preceding examples Ex1 to Ex18, wherein a maximum transverse dimension of the susceptor wires is equal to or smaller than 500 micrometer, in particular 300 micrometer, preferably 200 micrometer, more preferably 100 micrometer.

Example Ex20: The method according to any one of the preceding examples Ex1 to Ex19, wherein a cross-section of the susceptor wires has a circular shape or an oval shape or an elliptical shape or a triangular shape or a rectangular shape or a quadratic shape or polygonal shape.

Example Ex21: The method according to any one of the preceding examples Ex1 to Ex20, wherein the susceptor wires comprise a susceptor material which is electrically conductive and either ferromagnetic or ferrimagnetic.

Example Ex22: The method according to example Ex21, wherein the susceptor material of the susceptor wires comprises or consists of a metal, for example ferritic iron, or stainless steel, in particular a grade 410, grade 420, or grade 430 stainless steel; or a ferrimagnetic ceramic.

Example Ex23: The method according to any one examples Ex21 or Ex22, wherein the susceptor wires further comprise a ferromagnetic or ferrimagnetic temperature marker material in addition to the susceptor material.

Example Ex24: The method according to example Ex23, wherein the temperature marker material of the susceptor wires comprises or consists of nickel or a nickel alloy.

Example Ex25: An apparatus for applying susceptor wires to an aerosol-forming substrate, in particular for use in a method according to any one of the preceding examples Ex1 to Ex24, the apparatus comprising: a wire supply for providing a plurality of susceptor wires, and a substrate supply for providing an aerosol-forming substrate in the form of a sheet material to or past the wire supply, enabling the wire supply to deposit the susceptor wires on a main outer surface of the sheet material.

Example Ex26: The apparatus according to example Ex25, wherein the wire supply is configured and arranged to provide and deposit the plurality of susceptor wires on the main outer surface of the sheet material in substantially parallel alignment to each other.

Example Ex27: The apparatus according to any one of examples Ex25 or Ex26, wherein the wire supply comprises one or more bobbins the susceptor wires are provided on and supplied from to the sheet material.

Example Ex28: The apparatus according to any one of examples Ex25 to Ex27, wherein the wire supply comprises a plurality of bobbins, one for each susceptor wire.

Example Ex29: The apparatus according to example Ex28, wherein the bobbins each have a bobbin axis and wherein the bobbins are arranged with respect to the bobbin axes parallel next to each other, in particular coaxially next to each other.

Example Ex30: The apparatus according to any one of examples Ex25 to Ex29, wherein the substrate supply comprises a conveyor belt or one or more rollers for moving the aerosol-forming substrate in the form the sheet material relative to (in particular past) the wire supply in a conveying direction, the conveying direction preferably being parallel to a plane defined by the sheet material or parallel to a plane tangent to the sheet material at a place of wire.

Example Ex31: The apparatus according to any one of the examples Ex25 to Ex30, wherein the wire supply is configured and arranged such that immediately before the deposition on the main outer surface of the sheet material a projection of the length extension of the susceptor wires onto the plane defined by the sheet material or onto the plane tangent to the sheet material at the place of wire deposition is substantially parallel to the conveying direction.

Example Ex32: The apparatus according to any one of examples Ex25 to Ex31, wherein the wire supply is configured to be moved relative to (in particular across/along) the sheet material in a plane parallel to a plane defined by the sheet material or parallel to a plane tangent to the sheet material at a place of wire deposition, especially in a direction parallel to a projection of the length extension of the susceptor wires onto the respective plane immediately before the deposition on the main outer surface of the sheet material.

Example Ex33: The apparatus according to any one of examples Ex25 to Ex32, wherein the wire supply is configured and arranged such that an angle between the length extension of the susceptor wires when leaving the wire supply and a plane defined by the sheet material is in a range between 0 degrees and 90 degrees, in particular between 0 degrees and 80 degrees, preferably between 10 degrees and 45 degrees; or wherein an angle between the length extension of the susceptor wires when leaving the wire supply and a plane tangent to the sheet material at a place of wire deposition is in a range between 0 degrees and 90 degrees, in particular between 0 degrees and 80 degrees, preferably between 10 degrees and 45 degrees.

Examples will now be further described with reference to the schematic figures (not to scale) in which:

FIG. 1 shows schematically a top view of an apparatus according to the present invention;

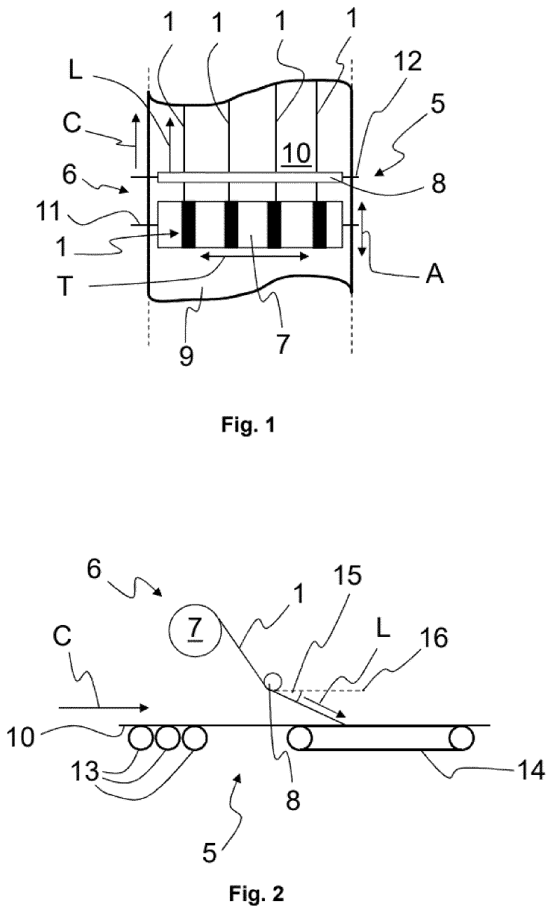

FIG. 2 shows schematically a lateral view of an apparatus according to the present invention;

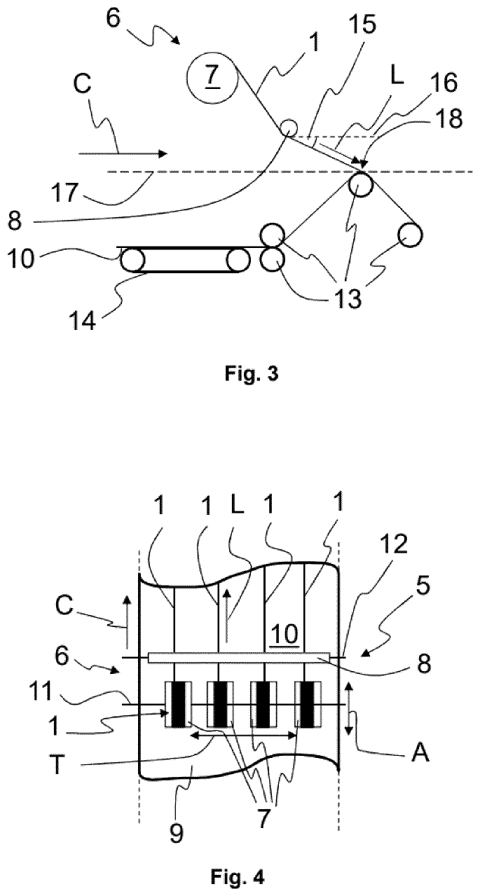

FIG. 3 shows schematically a lateral view of an apparatus according to another embodiment of the present invention;

FIG. 4 shows schematically a top view of an apparatus according to another embodiment of the present invention;

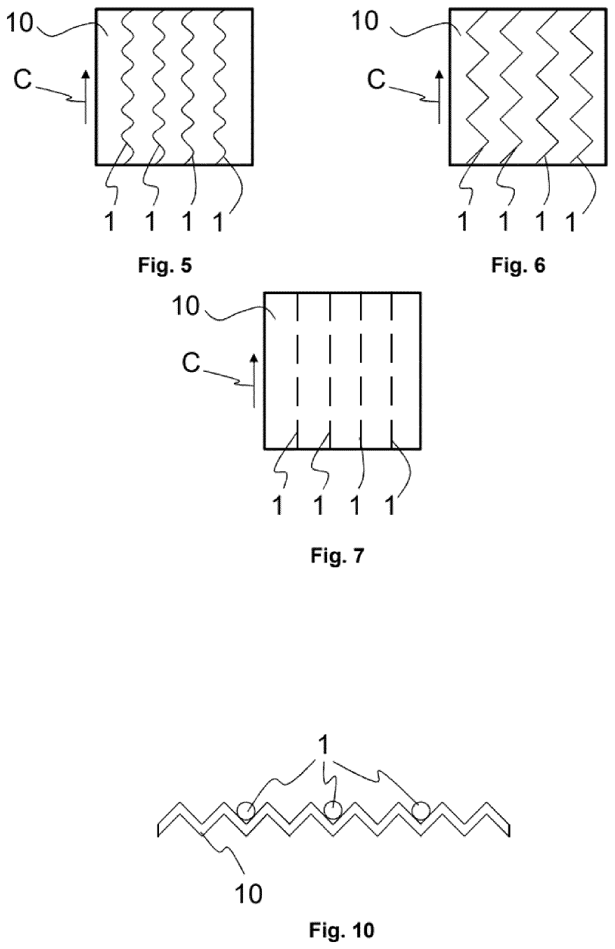

FIG. 5 shows schematically a deposition pattern of the susceptor wires according to the present invention;

FIG. 6 shows schematically a deposition pattern of the susceptor wires according to another embodiment of the present invention;

FIG. 7 shows schematically a deposition pattern of the susceptor wires according to yet another embodiment of the present invention;

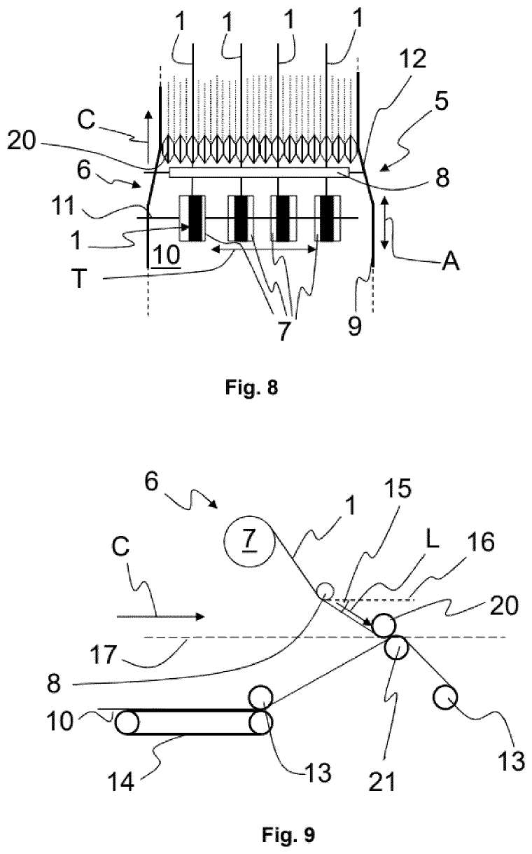

FIG. 8 shows schematically a top view of an apparatus according to yet another embodiment of the present invention;

FIG. 9 shows schematically a lateral view of the apparatus of FIG. 8; and

FIG. 10 shows schematically a cross-sectional view of a crimped sheet material with susceptor wires deposited thereon:

All examples shown in the figures are schematic and not to scale.

An embodiment of an apparatus 5 according to the present invention for applying susceptor wires 1 to an aerosol-forming substrate according to the method of the present invention is shown schematically in a top view in FIG. 1 and in a lateral view in FIG. 2. The apparatus 5 comprises a wire supply 6, the wire supply comprising a bobbin 7 and a guiding roller 8. Four susceptor wires 1 are provided coiled on the bobbin 7. The apparatus 5 further comprises a substrate supply for providing an aerosol-forming substrate 9 in the form of a sheet material 10. In the example shown in FIG. 1, the sheet material 10 lies in the drawing plane, but other orientations of the sheet material 10, as will be explained later, may be possible. The sheet material 10 may be a finite sheet with a given length, or may be, as suggested by the dashed lines, a continuous substrate sheet.

The bobbin 7 and the guiding roller 8 are arranged vertically above the sheet material 10 and mounted such as being rotatable on an axle 11 and an axle 12, respectively. A projection of the orientation of the axle 11 and axle 12, respectively, lies in the plane of the sheet material 10. The sheet material 10 is conveyed past the wire supply 6 in a conveying direction C, as will be explained later with respect to FIG. 2, either continuously or stepwise. The conveying direction C is preferably parallel to the plane defined by the sheet material 10 or to a plane tangent to the sheet material 10 at a place of wire deposition.

As the sheet material 10 is moved past the wire supply 6, the susceptor wires 1 are uncoiled from the bobbin 7 and deposited on a main outer surface of the sheet material 10 in substantially parallel arrangement to each other and to the conveying direction C. The guiding roller 8 may be provided with grooves for supporting the correct alignment of the susceptor wire 1 with respect to the sheet material 10 and/or be configured to provide a desired tension of the susceptor wires 1 during deposition. Alternatively, or in addition to the movement of the sheet material 9 in the conveying direction C, the wire supply 6 may be moved relative to the sheet material 10, in particular across/along the sheet material 10, in a plane parallel to the plane defined by the sheet material 10 or to a plane tangent to the sheet material 10 at a place of wire deposition. The movement across the sheet material 10 is suggested by the double arrow T, while the movement along the sheet material 10 is suggested by the double arrow A.

FIG. 2 schematically shows the apparatus 5 of FIG. 1 in a lateral view. As may be seen from FIG. 2, the wire supply 6 is arranged vertically above the sheet material 10. The sheet material 10 may be moved in the conveying direction C past the wire supply 6 by means of one more rollers 13 and/or one or more conveyor belts 14. An angle 15 between the length extension L of the susceptor wires 1 and a plane 16 parallel to the sheet material 10, suggested by the dashed line, when the susceptor wires 1 leave the wire supply 6, in the example shown in FIG. 2 when the susceptor wires 1 leave the guiding roller 8, is in a range between 0 degrees and 90 degrees, preferably between 0 degrees and 80 degrees, in particular between 10 degrees and 45 degrees.

FIG. 3 schematically shows another embodiment of the apparatus 5 in a lateral view. While in the apparatus 5 shown in FIG. 1 and FIG. 2 the sheet material 10 lies flat in a plane during deposition of the susceptor wires 1 on the main outer surface of the sheet material 10, in FIG. 3 the orientation of the plane of the sheet material 10 varies along a machine direction. Accordingly, the angle 15 is defined as between the length extension L of the susceptor wires 1 and a plane 16 parallel to a plane 17 tangent to the sheet material 10 at a place of wire deposition 18, suggested by the dashed line, when the susceptor wires 1 leave the wire supply 6, in the example shown in FIG. 3 when the susceptor wires 1 leave the guiding roller 8, is in a range between 0 degrees and 90 degrees, preferably between 0 degrees and 80 degrees, in particular between 10 degrees and 45 degrees. The conveying direction C is also parallel to the plane tangent to the sheet material 10 at a place of wire deposition 17

FIG. 4 shows another embodiment of an apparatus 5, similar to the apparatus 5 shown in FIG. 1. However, in the apparatus 5 of FIG. 4, the susceptor wires 1 are each provided on a single bobbin 7. The bobbins 7 are arranged next to each other on the axle 11 and are therefore coaxial. The conveying of the sheet material 10 may be as shown in FIG. 2 or in FIG. 3.

As described above, the wire supply 6 may be moved relative to the sheet material 10, in particular across/along the sheet material 10, in a plane parallel to the plane defined by the sheet material 10 or parallel to the plane 17 tangent to the sheet material 10 at the place of wire deposition 18. As an example, if the wire supply 6 of the apparatus 5 as shown in FIG. 1 or FIG. 4 is moved across the sheet material 10, as suggested by the double arrow T, during deposition of the susceptor wires 1, the susceptor wires 1 may be deposited in a sinusoidal-wave pattern as shown in FIG. 5, or in staggered (sawtooth) pattern, as shown in FIG. 6 on the main outer surface of the sheet material 10. The susceptor wires 1 are arranged such that a distance between two neighboring susceptor wires 1 in a direction perpendicular to the conveying direction C and parallel to the plane defined by the sheet material 10 or parallel to the plane 17 tangent to the sheet material 10 at the place of wire deposition 18 is constant along a length extension L of the susceptor wires 1.

As described above, in an alternative embodiment, the susceptor wires 1 may be cut to length, either before or during deposition on the main outer surface of the sheet material 10, as shown in FIG. 7. In this regard, the wire supply 6 may comprise cutting means, for example a cutting roller, for cutting the susceptor wires 1 shortly before or during deposition on the main outer surface of the sheet material 10. Alternatively, the susceptor wires may be provided already cut to length to the wire supply 6.

When the susceptor wires 1 are deposited on the main outer surface of the sheet material 10 continuously, the susceptor wires 1 are preferably cut simultaneously with the sheet material 10 in a subsequent step where the sheet material 10 may be crimped and gathered to form a substrate element for an aerosol-generating article.

In this regard, FIG. 8 shows another embodiment of the apparatus 5 similar to the apparatuses shown in FIG. 1 to FIG. 4. The apparatus 5 is schematically shown in FIG. 8 in a top view and in FIG. 9 in a lateral view. The arrangement of the bobbin(s) 7 may be as shown in FIG. 1 or FIG. 4. The apparatus 5 further comprises a crimping unit 19. The crimping unit 19 may comprise intermeshing grooved rollers 20 and 21 for crimping the sheet material 10, preferably in a longitudinal direction parallel to a machine direction of the apparatus 5, which in the example shown in FIG. 8 and FIG. 9 is also parallel to the conveying direction C. The crimped sheet material 10 is therefore corrugated when being conveyed between the grooved rollers 20 and 21. The susceptor wires 1 are then deposited on the sheet material 10 according to the example shown in FIG. 8 and FIG. 9 during crimping of the sheet material 10. Alternatively, the susceptor wires 1 may be deposited on the sheet material 10 after crimping. The susceptor wires are guided between the grooved rollers 20 and 21 such that the susceptor wires 1 are deposited within the corrugations (suggested by the dotted lines) of the sheet material 10, as shown exemplarily in FIG. 10 in a schematic cross-sectional view of the sheet material 10 after crimping.

Deposition of the susceptor wires 1 during or after crimping has the advantage that, since the sheet material 10 is corrugated, the created corrugations are particularly advantageous for accommodating the susceptor wires 1 during deposition, thereby simplifying the deposition and also improving parallel alignment and distribution of the susceptor wires 1. In addition, the susceptor wires 1 accommodated within the corrugations may be at least partially surrounded by the sheet material 10. The sheet material 10 may hence provide a clamping effect of the susceptor wires 1. Alternatively or additionally, a sticky agent, in particular glycerol, may be applied to the main outer surface of the sheet material to increase adherence of the susceptor wires 1 when deposited.

For the purpose of the present description and of the appended claims, except where otherwise indicated, all numbers expressing amounts, quantities, percentages, and so forth, are to be understood as being modified in all instances by the term “about”. Also, all ranges include the maximum and minimum points disclosed and include any intermediate ranges therein, which may or may not be specifically enumerated herein. In this context, therefore, a number A is understood as A ±5% of A. Within this context, a number A may be considered to include numerical values that are within general standard error for the measurement of the property that the number A modifies. The number A, in some instances as used in the appended claims, may deviate by the percentages enumerated above provided that the amount by which A deviates does not materially affect the basic and novel characteristic(s) of the claimed invention. Also, all ranges include the maximum and minimum points disclosed and include any intermediate ranges therein, which may or may not be specifically enumerated herein.

1.-15. (canceled)

16. A method of applying susceptor wires to an aerosol-forming substrate for an inductively heatable aerosol-generating article, the method comprising the steps of:
providing an aerosol-forming substrate in the form of a sheet material;
providing a plurality of susceptor wires from a wire supply; and
depositing the plurality of susceptor wires on a main outer surface of the sheet material,
wherein the aerosol-forming substrate is made from a substrate slurry casted into the form of the sheet material, and
wherein the plurality of susceptor wires are deposited on the casted substrate slurry.

17. The method according to claim 16, wherein the plurality of susceptor wires are provided and deposited on the main outer surface of the sheet material in substantially parallel alignment to each other.

18. The method according to claim 16, wherein the plurality of susceptor wires are continuous susceptor wires, each provided from a bobbin being part of the wire supply.

19. The method according to claim 16, wherein during depositing the susceptor wires on the main outer surface of the sheet material, the sheet material is moved relative to the wire supply in a conveying direction.

20. The method according to claim 19, wherein the conveying direction is parallel to a plane defined by the sheet material or parallel to a plane tangent to the sheet material at a place of wire deposition.

21. The method according to claim 16,
wherein an angle between a length extension of the susceptor wires when leaving the wire supply and a plane defined by the sheet material is in a range between 0 degrees and 90 degrees, or
wherein an angle between a length extension of the susceptor wires when leaving the wire supply and a plane tangent to the sheet material at a place of wire deposition is in a range between 0 degrees and 90 degrees.

22. The method according to claim 16,
wherein an angle between a length extension of the susceptor wires when leaving the wire supply and a plane defined by the sheet material is in a range between 10 degrees and 45 degrees, or
wherein an angle between the length extension of the susceptor wires when leaving the wire supply and a plane tangent to the sheet material at a place of wire deposition is in a range between 10 degrees and 45 degrees.

23. The method according to claim 16, wherein the plurality of susceptor wires are continuous susceptor wires.

24. The method according to claim 16, wherein the susceptor wires are deposited on the main outer surface of the sheet material prior to drying the casted substrate slurry.

25. The method according to claim 16, wherein the aerosol-forming substrate in the form of the sheet material is a continuous substrate sheet.

26. The method according to claim 25, wherein the susceptor wires are deposited on the main outer surface of the sheet material during or after crimping the continuous substrate sheet.

27. The method according to claim 25, wherein the susceptor wires are deposited on the main outer surface of the sheet material during or after crimping the continuous substrate sheet in a machine direction of the continuous substrate sheet.

28. The method according to claim 25, wherein the susceptor wires provided from the wire supply are fed into grooves of a crimping roller used for crimping the continuous substrate sheet such that the susceptor wires are deposited within corrugations formed during crimping.

29. The method according to claim 16, wherein a maximum transverse dimension of the susceptor wires is a range between 10 micrometers and 500 micrometers.

30. The method according to claim 16, wherein a maximum transverse dimension of the susceptor wires is equal to or smaller than 500 micrometers.

31. The method according to claim 16, wherein the susceptor wires comprise a susceptor material that is electrically conductive and either ferromagnetic or ferrimagnetic.

32. The method according to claim 31, wherein the susceptor material of the susceptor wires comprises a metal or stainless steel or a ferrimagnetic ceramic.

33. An apparatus for applying susceptor wires to an aerosol-forming substrate in the method according to claim 16, the apparatus comprising:
a wire supply configured to provide a plurality of susceptor wires; and
a substrate supply configured to provide an aerosol-forming substrate made from a substrate slurry casted into the form of a sheet material to or past the wire supply, enabling the wire supply to deposit the susceptor wires on a main outer surface of the sheet material,
wherein the susceptor wires are deposited on the casted substrate slurry.
